(19) United States
(12) Patent Application Publication
(10) Pub. No.: US 2011/0304268 A1
(43) Pub. Date: Dec. 15, 2011

(54) LIGHTING DEVICE HAVING A SEMICONDUCTOR LIGHT SOURCE AND AT LEAST ONE SENSOR

(75) Inventors: Ralph Bertram, Nittendorf (DE); Moritz Engl, Regensburg (DE); Markus Hofmann, Bad Abbach (DE)

(73) Assignee: OSRAM GESELLSCHAFT MIT BESCHRAENKTER HAFTUNG, Muenchen (DE)

(21) Appl. No.: 13/202,582

(22) PCT Filed: Feb. 3, 2010
(86) PCT No.: PCT/EP10/51312

§ 371 Date: Aug. 22, 2011

(30) Foreign Application Priority Data
Feb. 23, 2009 (DE) 10 2009 010 180.2

(51) Int. Cl. H05B 37/02

(52) U.S. Cl. 315/46; 315/51

(57) ABSTRACT

In various embodiments, a lighting device is provided, which may include at least one semiconductor light source, at least one sensor and evaluation electronics functionally connected to the at least one sensor, wherein the evaluation electronics are arranged to trigger at least one action of the lighting device upon at least one predetermined sensor signal of the at least one sensor.

The invention relates to a lighting device including at least one semiconductor light source and a method for operating a lighting device including at least one semiconductor light source.

Retrofit lamps with semiconductor light sources are known. A semiconductor retrofit lamp is provided to replace conventional lamps, such as incandescent lamps and halogen lamps. To this end, a semiconductor retrofit lamp includes a conventional base and, advantageously, its external contour does not substantially exceed the dimensions of the conventional lamp to be replaced. Nowadays, typical LED lamps, and also LED retrofit lamps, include light-emitting diodes (LEDs) and a lens (e.g. a translucent—opaque or transparent—cover such as a bulb or a cover disk and/or an optical component such as a reflector or a lens), a heat sink or a carrier, control electronics and a base.

The object of the present invention is to provide a possibility for a more versatile use of a lighting device.

This object is achieved by means of a lighting device and a method according to the respective independent claim. Preferred embodiments can be derived in particular from the dependent claims.

The lighting device is equipped with at least one semiconductor light source, wherein the lighting device includes at least one sensor and a logic circuit functionally connected to the at least one sensor, which is arranged to trigger at least one action of the lamp upon at least one predetermined sensor signal of the at least one sensor. In the following, this logic circuit will be referred to simply as the “evaluation electronics”.

The sensor enables the lighting device automatically to recognize changing ambient and/or operating parameters and, by means of suitably arranged evaluation electronics, to react flexibly thereto. This in turn enables the lighting device to be used more diversely, e.g. for the performance of functions other than normal lighting and/or for use in demanding environments. This is because the lighting device now includes an “intelligence” and can in particular perceive and further process internal physical parameters and ambient parameters.

The lighting device can be embodied as a light or as a general light fixture (“fixture”)—e.g. as a unit with a lamp. The lighting device can also be embodied as a lamp: this has the advantage that the new, sensor-assisted functions can be implemented at the user side without any functional modification to the light operating the lamp.

The lamp can be a retrofit lamp. This enables the implementation of the new sensor-assisted functions at the user side by simply replacing the lamp and without any modification to the light.

The at least one sensor can, for example, include a moisture sensor, a smoke sensor, a temperature sensor, an acoustic sensor, a motion sensor, a brightness sensor, a pressure sensor, an acceleration sensor, a color sensor and/or a position sensor.

The lighting device can in particular include at least one moisture sensor, wherein the evaluation electronics can be arranged to activate or amplify a heat source of the lighting device when a sensor signal of the at least one moisture sensor reaches or exceeds a predetermined moisture threshold. The lighting device can include a dedicated heating element, in particular a resistance heating element and/or an IR LED, as a heat source.

For example, the moisture sensor can be used to protect the lighting device, and in particular the light source, against the penetration of moisture. The light source(s) can absorb moisture through a casting compound (e.g. made of silicone) or through possible gaps between their connection legs and the housing of the light source(s). In the worst case, the moisture can damage the light source(s) and result in the failure of the light source(s). This type of damage can in particular occur when the light source(s) are exposed to moisture for a lengthy period and are not operated or only operated at a very low current so that moisture is not baked out of the housing. An operation of this kind is conceivable, for example, in emergency lighting located in a moist environment and which is not normally in operation. In an emergency, however, the light is required to function when a safety-relevant part is involved. Especially for use in moist environments, lighting devices, e.g. lights or lamps, can be mounted in a dust-proof and moisture-proof housing in order to prevent the moisture damaging the electronics and/or the light source(s). This protection by the housing is described by so-called “IP degrees of protection”. However, even housings with this highest IP degree of protection are not able completely to prevent the penetration of moisture.

The moisture sensor is used to sense a moisture value or a measured value correlated therewith (e.g. resistance value) in the interior of the lighting device and relay it to the evaluation electronics. The evaluation electronics can identify from the moisture value determined whether the moisture in the interior is too high and consequently could cause damage. The evaluation electronics can then trigger an action to reduce the moisture in the lighting device to a non-critical level. To this end, the evaluation electronics can, for example, activate or amplify a heat source in the interior of the lighting device so that the interior of the lighting device is baked.

The type of heat source is not restricted and can, for example, be the light source(s) whose heat loss during light generation is used for the baking. For the baking, the at least one light source is then either switched on or ramped up from a lower luminous intensity to a higher luminous intensity. The heat source can also include at least one resistance heating, which is supplied with a defined current. The heat source can also include a dedicated infrared radiator, e.g. an infrared light-emitting diode (IR LED).

The moisture sensor can advantageously be positioned as closely as possible to the light source and measures the moisture at the light source with a high degree of accuracy. The moisture sensor can, for example, be a simple capacitive sensor (e.g. a sensor from the series HCH-1000 made by the company Honeywell) or even a sensor offering an additional function, such as a temperature measurement, e.g. a sensor from the SHTx series made by the company Sensirion.

Recognition whether the moisture in the interior of the lighting device is too high can advantageously be achieved by comparison with one or more predetermined moisture thresholds. If, for example, in one possible embodiment a predetermined moisture threshold of 60% relative humidity (RH) is reached or exceeded, the evaluation electronics activate the heat source of the lighting device and hence bake the moisture out of the lighting device. When the level drops below the moisture threshold, the heat source is deactivated again. In a further possible embodiment, the heat source is activated when a prespecified first moisture value is exceeded, e.g. 60% RH, and the moisture baked out of the housing. The heat source is only deactivated again when the level drops below a predefined second moisture value, which is lower than the first moisture value, e.g. 50% RH. This involves the traversal of a “moisture hysteresis loop”, which prevents the at least one heat source for baking out the moisture from being switched on and then back off again at short intervals.

The use of the moisture sensor has the advantages that (a) the housing can be less complicated to construct since a lower IP degree of protection can be selected, (b) the reliability of the lighting device can be increased due to the fact that moisture-induced damage, in particular to the light source and the electronics, can be minimized and (c), particularly in the case of safety-relevant lighting devices (e.g. for emergency lighting in a tunnel etc.), creeping damage due to moisture can be avoided.

The use of a smoke sensor enables the lighting device to be simultaneously used as a smoke detector. The lighting device can, for example, emit an alarm signal on the detection of a predetermined amount of smoke. The alarm signal can be an optical signal, e.g. flashing and/or a color change of the light emitted by the lighting device, e.g. a color change from white to red. The lighting device can additionally include an acoustic signal transmitter (loudspeaker, siren, horn etc.), which, in the case of an alarm, emits an acoustic signal as an alarm signal additionally or alternatively to the optical signal. It is also possible to use the transmission (e.g. effected wirelessly or via the modulation of the mains voltage) of an alarm signal to a central monitoring unit, which then relays or triggers an alarm.

The use of a temperature sensor enables an outside temperature and/or a temperature in the housing of the lighting device to be monitored. If temperatures are achieved at which reliable operation of the lighting device is no longer guaranteed (overheating), the power to the lighting device can be throttled or the lighting device can be switched off completely. Alternatively or additionally, it is also possible for an (e.g. optical or acoustic) alarm signal to be emitted.

The use of an acoustic sensor in the lighting device enables the lighting device to be controlled by noise, for example. For example, the lighting device can be switched on by a single first clapping of the hands and switched off by a further clapping of the hands.

The use of a motion sensor in the lighting device enables the lighting device to be simultaneously used as a motion detector. As soon as, for example, someone approaches the lighting device, it comes on and/or emits an acoustic signal. This enables a separate motion detector to be spared.

A brightness sensor can be used to measure the brightness of the ambient light. If, for example, in one possible embodiment, the level drops below a first brightness threshold for the ambient light, the lighting device is switched on, if a second brightness threshold is exceeded, the lighting device then switches off again. The first brightness threshold can be equal to the second brightness threshold, alternatively the second brightness threshold can be higher than the first brightness threshold in order to a prevent the constant switching-on and switching-off of the lighting device. It is also possible to provide a twilight setting so that, as the ambient light decreases, the dim level of the lighting device is increased.

If a pressure sensor, in particular an air pressure sensor, is used, this sensor can respond, for example in the case of a pressure drop, e.g. in an airplane or in a hyperbaric chamber, and switch on the light source(s) to provide emergency lighting and/or emit an acoustic signal.

An acceleration sensor can be used to trigger the evaluation electronics if an acceleration threshold sensed by the acceleration sensor is exceeded, for example in the case of an earthquake, and initiate the switching-on of the light source(s), optionally also by means of an integrated battery-powered emergency power supply.

The use of a position sensor can, for example, prevent location-induced overheating of the lighting device. For example, LED-lighting devices dissipate the heat formed during light generation via a heat sink. The cooling efficiency of heat sinks, which are generally based on the free convection of air, is frequently determined by their mounting position. For example, horizontal installation of the flow channel generally impairs the efficiency of the heat sink. This mounting position can be determined from the position sensor so that, in the case of a non-optimum position, the evaluation electronics can reduce the power of the lighting device in order to avoid overheating.

The color sensor can be used to detect a change to the beam color due to a temperature and optionally, with a color-tunable light source, correct it by a color change of the light emitted by the lighting device. It is also possible to adjust the luminosity, in order to limit the change to the beam color.

To this end, and also generally for the processing of sensor values and/or control of the semiconductor light source(s), the lighting device can advantageously be equipped with a suitable control circuit. Additionally or alternatively, the lighting device can include—wireless or wire-bound—data transmission means for the transmission of measured values and/or reception of control signals. The control circuit can advantageously also be used to perform a function test. Alternatively, the lighting device can include a dedicated function test unit for the performance of a function test.

In response to a predetermined sensor signal of the at least one sensor, the lighting device can generally inter alia initiate
a switching-on of the lighting device,
a switching-off of the lighting device,
a brightness change of the lighting device,
a flashing of the lighting device,
a color change of the light emitted from the lighting device,
an emission of an acoustic signal by means of the lighting device,
a heating up of the lighting device and/or
a transmission of a data signal.

The at least one sensor can, for example, be arranged with the at least one semiconductor light source on a common substrate (e.g. a printed circuit board); arranged on a lens of the lighting device, thus enabling direct coupling to the incident ambient light; on a heat sink of the lighting device, thus enabling a reliable direct temperature measurement, e.g. taking into account (safety) thresholds for exposed surfaces and/or arranged on a base of the lighting device. Generally, the sensor can be arranged on an outer side of the lighting device or within the lighting device. For example, the sensor can be integrated in the lens, e.g. in a primary lens, secondary lens and/or a cover. The sensor can also be seated in the housing directly on a printed circuit board provided for mounting the light source(s), on a driver board or—for particularly simply mounting—on a separate printed circuit board.

The at least one sensor can be present as a combined sensor/(evaluation) electronics element. For example, the sensor can be integrated in the evaluation electronics. This enables a separate component to be dispensed with, thus saving costs and space.

The at least one semiconductor light source can include at least one diode laser, advantageously however at least one light-emitting diode. The light-emitting diode can emit monochromatic or polychromatic light, e.g. white light. In the case of a plurality of light-emitting diodes, these can emit, for example, isochromatic (monochromatic or polychromatic) and/or heterochromatic light. For example, an LED module can comprise a plurality of LED chips (‘LED cluster’), which together can issue a white mixed light, e.g. in ‘cold white’ or ‘warm white’. To generate a white mixed light, the LED cluster preferably includes LED chips, which emit light in the primary colors red (R), green (G) and blue (B). Hereby, individual or a plurality of colors can also be generated simultaneously by a plurality of LEDs; for example, combinations RGB, RRGB, RGGB, RGBB, RGGBB etc. are possible. However, the color combination is not restricted to R, G and B. To generate a warm-white shade, it is also possible, for example, for one or more amber-colored LEDs (A) to be present. In the case of LEDs with different colors, these can also be controlled in such a way that the LED module emits in a tunable RGB-color range. To generate a white light from a mixture of blue light with yellow light, it is also possible to use LED chips provided with luminescent material, e.g. in surface mounting technology, e.g. in so-called chip-level conversion technology. It is also possible to use methods, such as red/green combination by means of conversion technology. Obviously, “conventional” volume conversion is also possible. An LED module can also include a plurality of white individual chips enabling simple scalability of the luminous flux to be achieved. The individual LEDs and/or the modules can be equipped with suitable lenses for beam guidance, e.g. Fresnel lenses, collimators, etc. Instead of or in addition to inorganic light-emitting diodes, e.g. based on InGaN or AlInGaP, generally also organic LEDs (OLEDs) can also be used.

The lighting device can advantageously include a current-storage device, e.g. a battery or an accumulator so that in particular safety-relevant functions (fire detection by means of smoke detection, earthquake detection by acceleration detection etc.) continue to function even in the event of an interruption to the power supply.

The method is used to operate a lamp with at least one semiconductor light source and at least one sensor, wherein at least one action of the lamp is triggered upon at least one predetermined sensor signal of the at least one sensor.

The following figures describe the invention schematically in more detail with reference to exemplary embodiments. Hereby, for the sake of clarity, the same elements or elements with the same function are given the same reference numbers.

FIG. 1 shows a sectional side view of an LED retrofit lamp according to a first embodiment;

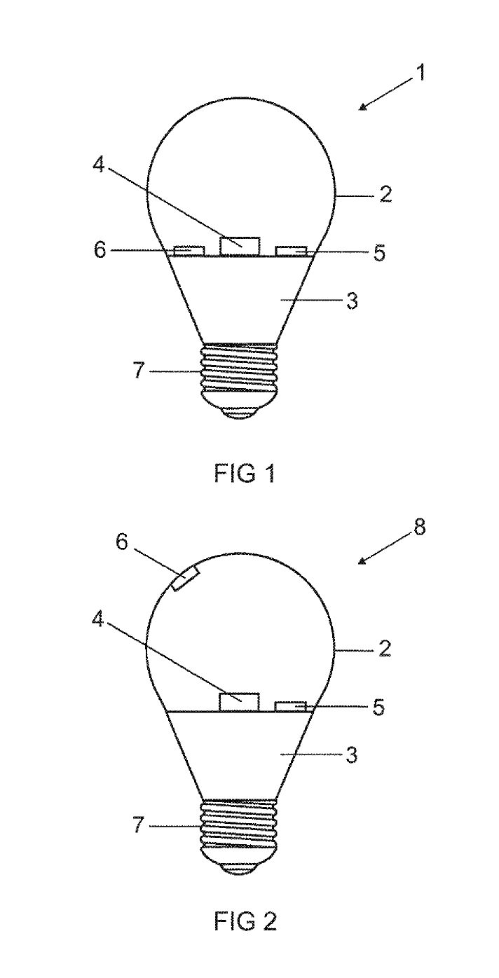

FIG. 2 shows a sectional side view of an LED retrofit lamp according to a second embodiment;

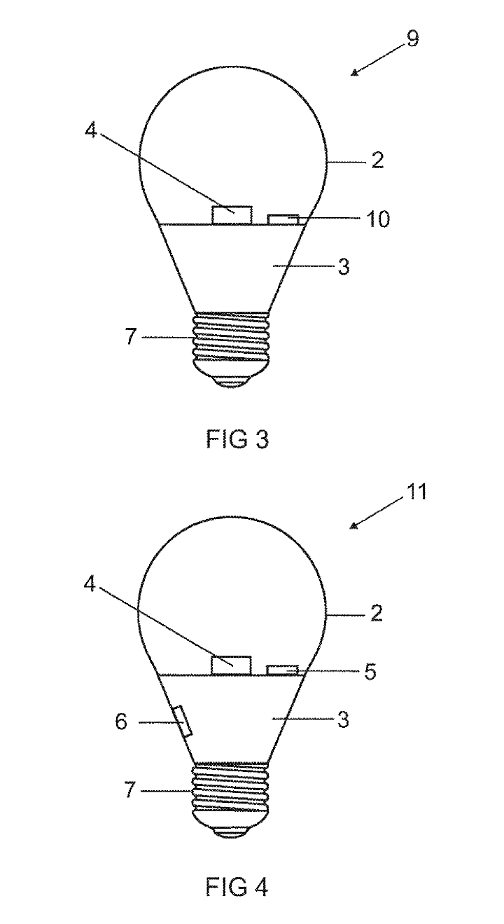

FIG. 3 shows a sectional side view of an LED retrofit lamp according to a third embodiment;

FIG. 4 shows a sectional side view of an LED retrofit lamp according to a fourth embodiment;

FIG. 5 shows a sectional side view of an LED retrofit lamp according to a fifth embodiment;

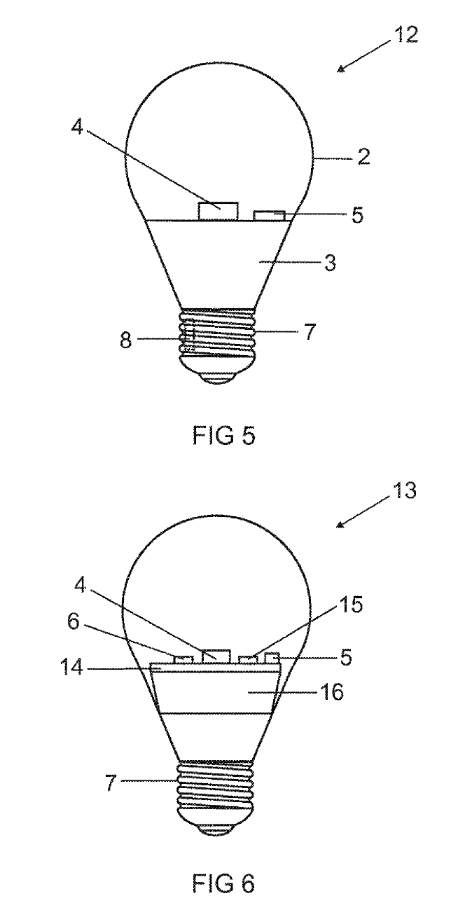

FIG. 6 shows a sectional side view of an LED retrofit lamp according to a sixth embodiment;

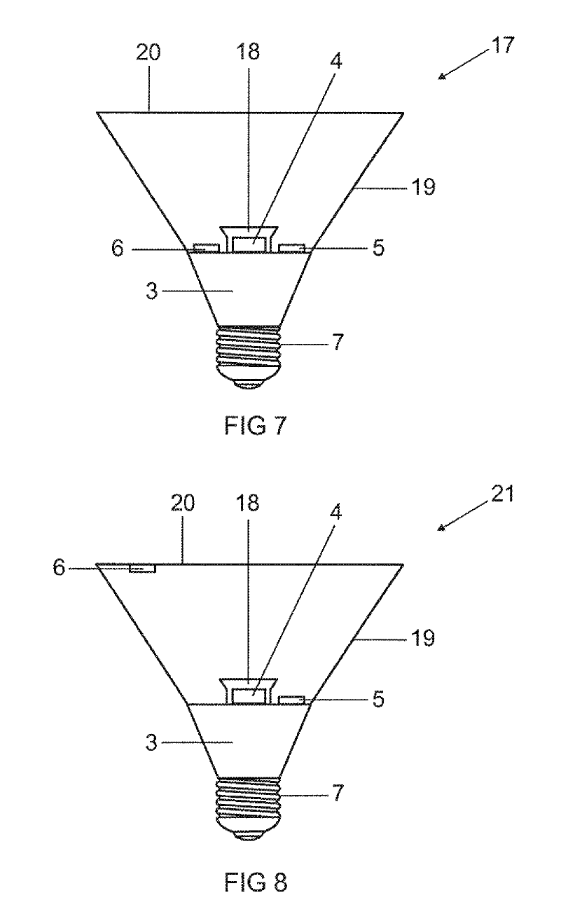

FIG. 7 shows a sectional side view of an LED retrofit lamp according to a seventh embodiment;

FIG. 8 shows a sectional side view of an LED retrofit lamp according to an eighth embodiment;

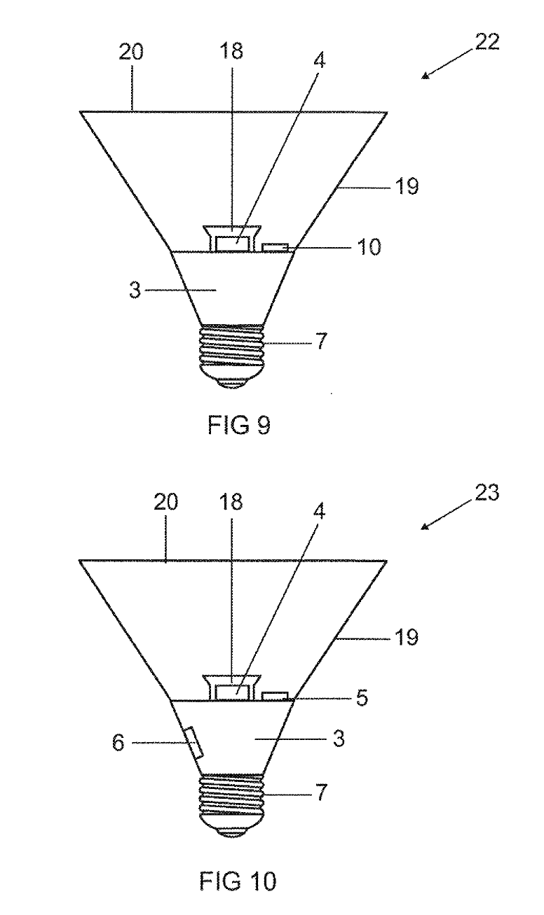

FIG. 9 shows a sectional side view of an LED retrofit lamp according to a ninth embodiment;

FIG. 10 shows a sectional side view of an LED retrofit lamp according to a tenth embodiment;

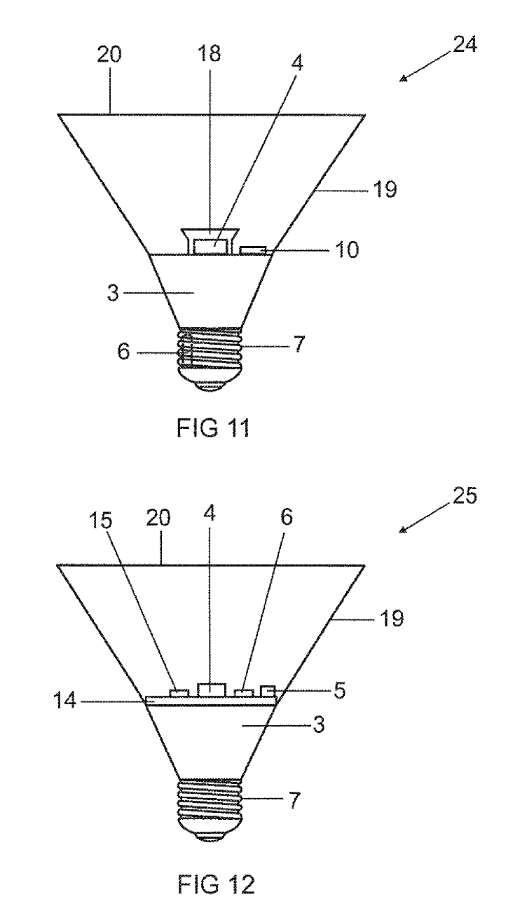

FIG. 11 shows a sectional side view of an LED retrofit lamp according to an eleventh embodiment;

FIG. 12 shows a sectional side view of an LED retrofit lamp according to a twelfth embodiment;

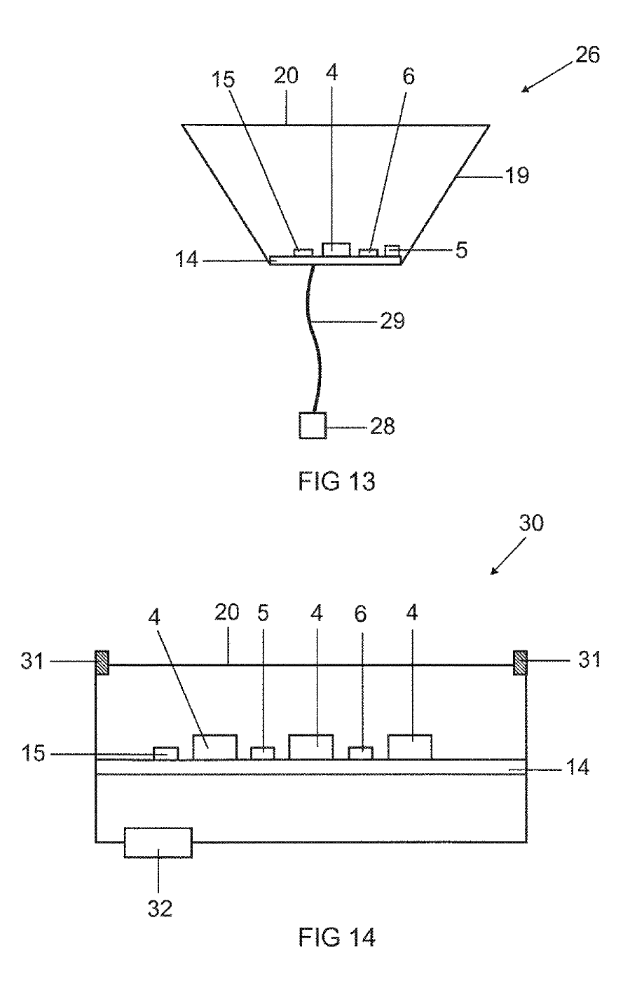

FIG. 13 shows a sectional side view of an LED light;

FIG. 14 shows a sectional side view of an LED light according to a further embodiment.

FIG. 1 shows a side view of an LED retrofit lamp 1 according to a first embodiment. The shape of the LED retrofit lamp 1 emulates the shape of a general-lighting-service lamp (“G-lamp” or “GLS-lamp”). To this end, the LED retrofit lamp 1 includes a translucent (opaque or transparent) bulb 2, which sits on a carrier 3. The carrier 3 bears on its surface facing the bulb 2 an LED 4 as a light source, electronics 5 and a sensor 6. The electronics 5 are connected to both the LED 4 and the sensor 6 and are used both to control the LED 4 and as evaluation electronics for the sensor 6. The carrier 3 is used simultaneously as a heat sink for the LED 4, the electronics 5 and optionally the sensor 6. The LED 4, electronics 5 and sensor 6 are mounted on a common printed circuit board (not shown) by means of a soldered connection. On its underside, the LED retrofit lamp 1 is equipped with a screw base 7 with an Edison thread (e.g. E27) to secure the lamp 1 and for the power supply for the LED 4, electronics 5 and sensor 6. During the operation of the LED retrofit lamp 1, the electronics 5 serve as a driver for the LED 4, which as a result emits light, here: white light, outward through the bulb 2. The sensor 6 is arranged close to the LED 4 and senses moisture within the bulb 2 by capacitive means. The raw sensor signals are transmitted as capacitance values to the electronics 5, which determine moisture values from the capacitance values. To this end, a characteristic is stored in the electronics 5 said characteristic reflecting a correlation between capacitance values and moisture values. If the moisture value determined in the bulb 2 reaches or exceeds a predetermined first moisture threshold, the LED 4 is operated by the electronics 5 at a predetermined power, in particular its maximum power. If the LED 4 had been switched off beforehand, it is switched on for this purpose; if the LED 4 was previously operated at a lower power, the power is increased accordingly; if the LED 4 was previously operated at the same or a higher power, the power is retained. The waste heat from the LED 4 bakes the interior of the bulb 2 so that the moisture is reduced. Only when a predetermined second moisture threshold, which is lower than the first moisture threshold, is reached again (from the top) or fallen below, do the electronics 5 switch off the LED 4 as soon as possible.

Alternatively to the embodiment of the sensor 6 as a moisture sensor, it can also be embodied as a smoke sensor, a temperature sensor, an acoustic sensor, a motion sensor, a brightness sensor, a pressure sensor, an acceleration sensor or a position sensor. The sensor 6 can also be attached to an outer side of the lamp 1.

FIG. 2 shows an LED retrofit lamp 8 according to a second embodiment, with which, unlike the case with LED retrofit lamp 1 in FIG. 1, the sensor 6 is attached on the inner side of the bulb 2 and communicates with the electronics by wires or wirelessly. The sensor 6 can alternatively also be attached to an outer side of the bulb 2.

FIG. 3 shows a side view of an LED retrofit lamp 9 according to a third embodiment with which, unlike the case with the LED retrofit lamp 1 in FIG. 1, the sensor function and the electronics are combined in one sensor/electronics module 10.

However, the sensor can also be attached on the carrier 3 of an LED retrofit lamp 11, as shown in FIG. 4, or on the base 7 of an LED retrofit lamp 12, as shown in FIG. 5. The sensor 6 can be attached within the LED retrofit lamp 11, 12 or to an outer side of the LED retrofit lamp 11, 12.

FIG. 6 shows a sectional side view of an LED retrofit lamp 13 according to a sixth embodiment. The LED 4, the electronics 5 and the sensor 6 are soldered onto a common printed circuit board 14. Also located on this printed circuit board 14 is a dedicated heating element 15, which is controlled by means of the electronics 5 and can be used instead of the light-emitting diode 4 to bake the bulb 2. A heat sink 16 is also shown as a compact region of the carrier 3.

FIG. 7 shows a sectional side view of an LED retrofit lamp 17 according to a seventh embodiment. The LED retrofit lamp 17 has a shape approximating the shape of a PAR (“parabolic aluminized reflector”) with a diameter of 38 eights of an inch (“PAR 38”). On the carrier 3, which also functions as a heat sink, the LED 4, the electronics 5 and the sensor 6 are attached to a common printed circuit board. The LED 4 is now connected to a primary lens 18, which guides the light emitted by the LED 4. Furthermore, a reflector 19 seated on the front side of the carrier 3 and extending in the circumferential direction is used for the beam guidance. The front side of the LED retrofit lamp 17 is formed from a translucent (transparent or opaque) cover disk 20 seated on the reflector 19. The reflector 19 reflects the radiation travelling indirectly from the primary lens 18 through the cover disk 20 outward. The LED retrofit lamp 17 otherwise works substantially in the same way as the LED retrofit lamp 1 in FIG. 1 and so it does not require any further description.

FIG. 8 shows an LED retrofit lamp 21 according to an eighth embodiment with which the sensor 6 is now attached to the cover disk 20 and communicates with the electronics 5 by wire-bound or wireless means.

FIG. 9 shows an LED retrofit lamp 22 according to a ninth embodiment, with which the sensor 6 is integrated in the electronics so that a combined sensor/evaluation component 10 with the LED 4 is arranged on a common printed circuit board.

FIG. 10 shows an LED retrofit lamp 23 according to a tenth embodiment, with which the sensor 6 is attached to the carrier 3.

FIG. 11 shows a side view of an LED retrofit lamp 24 according to an eleventh embodiment, with which the sensor 6 is attached to the base 7.

FIG. 12 shows a side view of an LED retrofit lamp 25 according to a twelfth embodiment. With this embodiment,—similarly to the case with the LED retrofit lamp 13 in FIG. 6—the LED 4, the electronics 5 and the sensor 6 are soldered onto a common printed circuit board 14. Also located on this printed circuit board 14 is a dedicated heating element 15, which is controlled by means of the electronics 5 and can be used instead of the light-emitting diode 4 for baking the bulb 2.

FIG. 13 shows an LED light 26, which may be used, for example, as a downlight etc. in an outside area. On a printed circuit board 14, similarly to the LED lamp 13 in FIG. 6 and the LED lamp 25 in FIG. 12, the LED 4, the electronics 5, the sensor 6 and a dedicated heat source 15 are arranged on a common printed circuit board 14. These elements 4 to 6, 14 are accommodated in a housing 27, which includes on the face end a translucent cover plate 20 for guiding the light emitted by the LED 4 outward. One or more optical components, such as lenses etc., can be integrated in the cover plate 20. The housing can, for example, be made of aluminum or plastic. The power supply is provided via a plug for connection to a power supply and a power cable 29 from the plug 28 to the printed circuit board 14.

FIG. 14 shows an LED light 30 similar to the LED light 26 in FIG. 13, but in this case a plurality of LEDs 4 are arranged on the printed circuit board 14. The translucent cover plate 20 is sealed from the housing 27 by a silicone seal 31 round the edge to prevent the ingress of moisture. However, this seal 31 is not completely tight and so a small amount of moisture is able to penetrate the interior of the LED light, which can damage it. To remove the penetrated moisture, the dedicated heat source can be operated as already described with respect to FIG. 6. The LED light 30 further includes a pressure-equalizing membrane 32.

Obviously, the present invention is not restricted to the exemplary embodiments shown. For example, it is also possible for two or more sensors of the same or different types to be arranged on the lighting device. It is also possible for the lighting device to contain a control circuit, e.g. in the form of an integrated circuit. It is also possible for a—integrated or dedicated—function test unit to be present for the performance of a function test. The lighting device can also include a current-storage device.

### LIST OF REFERENCE NUMBERS

1 LED retrofit lamp
2 Bulb
3 Carrier/heat sink
4 LED
5 Electronics
6 Sensor
7 Screw base
8 LED retrofit lamp
9 LED retrofit lamp
10 Combined sensor/electronics module
13 LED retrofit lamp
14 Printed circuit board
15 Heating element
16 Heat sink
17 LED retrofit lamp
18 Primary lens
19 Reflector
20 Cover disk
21 LED retrofit lamp
22 LED retrofit lamp
23 LED retrofit lamp
24 LED retrofit lamp
25 LED retrofit lamp
26 LED light
27 Housing
28 Plug
29 Power cable
30 LED light
31 Silicone seal
32 Pressure-equalizing membrane

1. A lighting device, comprising:
at least one semiconductor light source,
at least one sensor and evaluation electronics functionally connected to the at least one sensor,
wherein the evaluation electronics are arranged to trigger at least one action of the lighting device upon at least one predetermined sensor signal of the at least one sensor.

2. The lighting device as claimed in claim 1,
configured as a lamp.

3. The lighting device as claimed in claim 2,
configured as a retrofit lamp.

4. The lighting device as claimed in claim 1,
wherein the at least one sensor belongs to the group of sensors consisting of:
a moisture sensor;
a smoke sensor;
a temperature sensor;
an acoustic sensor;
a motion sensor;
a brightness sensor;
a pressure sensor;
an acceleration sensor;
a position sensor; and
a color sensor.

5. The lighting device as claimed in claim 4, further comprising:
at least one moisture sensor,
wherein the evaluation electronics are arranged to activate or amplify a heat source of the lighting when a sensor signal of the at least one moisture sensor reaches or passes a predetermined moisture threshold.

6. The lighting device as claimed in claim 5, further comprising:
a dedicated heating element as a heat source.

7. The lighting device as claimed in claim 6, wherein the dedicated heating element is a resistance heating element or an infrared light emitting diode.

8. The lighting device as claimed in claim 1,
wherein the at least one action belongs to the group consisting of:
a switching-on of the lighting device;
a switching-off of the lighting device;
a brightness change of the lighting device;
a flashing of the lighting device;
a color change of the light emitted by the lighting device;
an emission of an acoustic signal by means of the lighting device;
a heating up of the lighting device; and
a transmission of a data signal from the lighting device.

9. The lighting device as claimed in claim 1,
wherein the at least one sensor is arranged with the at least one semiconductor light source on a common substrate;
on at least one of
an optical element of the lighting device;
a carrier of the lighting device;
on a heat sink of the lighting device; and
a base of the lighting device.

10. The lighting device as claimed in claim 1, further comprising:
a combined sensor/evaluation electronics element.

11. The lighting device as claimed in claim 1:
wherein at least one sensor is arranged within the lighting device.

12. The lighting device as claimed in claim 1,
wherein the semiconductor light source comprises at least one light-emitting diode.

13. The lighting device as claimed in claim 1, further comprising:
a function tester for the performance of a function test.

14. The lighting device as claimed in claim 1, further comprising:
a current-storage device.

15. A method for operating a lighting device comprising at least one semiconductor light source and at least one sensor, the method comprising:
triggering at least one action of the lighting device upon at least one predetermined sensor signal.
